(19) United States
(12) Patent Application Publication
(10) Pub. No.: US 2003/0095230 A1
(43) Pub. Date: May 22, 2003

(54) Antimicrobial lenses and methods of their use related patent applications

(76) Inventors: Frank L. Neely, Jacksonville, FL (US); Ann-Marie W. Meyers, Jacksonville, FL (US); John B. Enns, Jacksonville, FL (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 10/183,883

(22) Filed: Jun. 25, 2002

Related U.S. Application Data
(63) Continuation-in-part of application No. 10/029,526, filed on Dec. 21, 2001.
(60) Provisional application No. 60/309,642, filed on Aug. 2, 2001.

(51) Int. Cl. G02C 7/02

(52) U.S. Cl. 351/159

(57) ABSTRACT

This invention relates to antimicrobial lenses containing at least one antimicrobial component and methods for their production.

### RELATED PATENT APPLICATIONS

This patent application claims priority of a provisional application, U.S. Ser. No. 60/309,642 which was filed on Aug. 2, 2001, and non-provisional application, U.S. Serial No. 10/029,526, which was filed on Dec. 21, 2001.

### FIELD OF THE INVENTION

This invention relates to antimicrobial lenses as well as methods of their production, and use.

### BACKGROUND OF THE INVENTION

Contact lenses have been used commercially to improve vision since the 1950s. The first contact lenses were made of hard materials. They were used by a patient during waking hours and removed for cleaning. Current developments in the field gave rise to soft contact lenses, which may be worn continuously, for several days or more without removal for cleaning. Although many patients favor these lenses due to their increased convenience, these lenses can cause some adverse reactions to the user. Continuous, extended wear of the lenses can encourage the buildup of bacteria or other microbes, particularly, Pseudomonas aeruginosa, on the surfaces of soft contact lenses. The build-up of bacteria and other microbes can cause adverse side effects such as contact lens acute red eye and the like. Although the problem of bacteria and other microbes is most often associated with the extended use of soft contact lenses, the build-up of bacteria and other microbes occurs for users of hard contact lens wearers as well.

Therefore, there is a need to produce contact lenses that inhibit the growth of bacteria or other microbes and/or the adhesion of bacteria or other microbes on the surface of contact lenses. Further there is a need to produce contact lenses which do not promote the adhesion and/or growth of bacteria or other microbes on the surface of the contact lenses. Also there is a need to produce contact lenses that inhibit adverse responses related to the growth of bacteria or other microbes.

Others have recognized the need to produce soft contact lenses that inhibit the growth of bacteria or other microbes. One reference discloses that silver, a known antimicrobial agent, can be incorporated into contact lenses using a silver zeolite to give an antimicrobial lens. This reference, EP 1050314 A1, teaches that a certain weight percentage of silver zeolites can be molded into a lens. The antimicrobial effect of the lenses of EP 1,050,314 is caused by the exchange of silver between the zeolites and the surrounding tissues. However, since the zeolites of EP 1,050,314 rapidly release silver, the antimicrobial activity of these lenses reduces rapidly as silver diffuses into the ocular environment and the surrounding tissues.

### DETAILED DESCRIPTION OF THE INVENTION

This invention includes an antimicrobial lens comprising at least one antimicrobial component.

As used herein, the term, “antimicrobial lens” means a lens that exhibits one or more of the following properties, 1) the inhibition of the adhesion of bacteria or other microbes to the lenses, 2) the inhibition of the growth of bacteria or other microbes on lenses, and 3) the killing of bacteria or other microbes on the surface of lenses or in an area surrounding the lenses. For purposes of this invention, adhesion of bacteria or other microbes to lenses, the growth of bacteria or other microbes on lenses and the presence of bacteria or other microbes on the surface of lenses is collectively referred to as “microbial colonization.” Such bacteria or other microbes include but are not limited to those organisms found in the eye, particularly Pseudomonas aeruginosa, Acanthamoeba species, Staphyloccus. aureus, E. coli, Staphyloccus epidermidis, and Serratia marcesens.

As used herein, the term “zeolites” means an aluminosilicate having a three dimensional skeletal structure that is generally represented by xM_{2/n} O.Al₂O₃.ySiO₂.zH₂O, written with Al₂O₃ as a basis, wherein M represents an ion- exchangeable cationic species, which is usually the ion of a monovalent or divalent metal; n corresponds to the valence of the metal; x is a coefficient of the metal oxide; y is a coefficient of silica; and z is the number of waters of crystallization. Examples of natural zeolites include analcime, chabazite, clinoptilolite, erionite, faujasite, mordenite, and phillipsite. Examples of synthetic zeolites include A-type zeolite, X-type zeolite, Y-type zeolite, and mordenite.

The term “antimicrobial component” refers to any metal ion, which (1) is soluble in an aqueous medium (2) may be incorporated into a lens without degrading the desired performance characteristics of the lens, including, but not limited to clarity, optical power, modulus and the like, (3) reduces the concentration of microbial colonization on and/or near the lens and (4) which does not harm or irritate the eye or ocular environment at concentrations which will be experienced during lens wear. The antimicrobial component is soluble in an aqueous medium and has the ability to permeate the lens (preferably in ionic form) and includes, but is not limited to, metal ions that have antimicrobial activity including, but not limited to, silver, copper, zinc, mercury, tin, lead, bismuth, cadmium, chromium, gold, platinum, palladium, cobalt and nickel ions or a combination of two or more of these metal ions. The preferred antimicrobial components are silver, zinc, and copper ions and the particularly preferred antimicrobial component is silver ions.

The antimicrobial activity of the lenses of the invention varies with the amount of antimicrobial component present in and/or on the lenses.

As used herein, the term “antimicrobial host” refers to any species with an affinity for an antimicrobial component which is greater than the affinity for an antimicrobial component possessed by the lens material. These hosts include, but are not limited to, zeolites, ligands, polyanionic polymers, acyclic polyether polymer compounds and the like.

As used herein, the term “lens” refers to an ophthalmic device that resides in or on the eye. These devices can provide optical correction or may be cosmetic. The term lens includes, but is not limited to, soft contact lenses, hard contact lenses, intraocular lenses, overlay lenses, ocular inserts, and optical inserts. Soft contact lenses are made from silicone elastomers or hydrogels, which include, but are not limited to, silicone hydrogels, and fluorohydrogels. Preferably, the lenses of the invention are soft contact lenses which are optically clear, with optical clarity comparable to currently available commercial lenses such as lenses made from etafilicon A, genfilcon A, lenefilcon A, polymacon, acquafilcon A, balafilcon A, and lotrafilcon A.

Suitable soft contact lens formulations are described in U.S. Pat. No. 5,710,302, WO 9421698, EP 406161, JP 2000016905, U.S. Pat. No. 5,998,498, U.S. Pat. App. No. 09/532,943, U.S. Pat. No. 6,087,415, U.S. Pat. No. 5,760,100, U.S. Pat. No. 5,776, 999, U.S. Pat. No. 5,789,461, U.S. Pat. No. 5,849,811, and U.S. Pat. No. 5,965,631. These patents as well as all other patents disclosed in this specification are hereby incorporated by reference in their entirety. In addition, antimicrobial lenses of the present invention may be made from the formulations of commercial soft contact lenses. Examples of commercially available soft contact lenses formulations include but are not limited to the formulations of etafilcon A, genfilcon A, lenefilcon A, polymacon, acquafilcon A, balafilcon A, and lotrafilcon A. The preferable contact lens formulations are etafilcon A, balafilcon A, acquafilcon A, lotrafilcon A, and silicone hydrogels, as prepared in U.S. Pat. No. 5,998,498, U.S. Pat. App. Ser. No. 09/532,943, a continuation-in-part of U.S. Pat App. Ser. No. 09/532,943, filed on Aug. 30, 2000, U.S. Pat. No. 6,087,415, U.S. Pat. No. 5,760,100, U.S. Pat. No. 5,776, 999, U.S. Pat. No. 5,789,461, U.S. Pat. No. 5,849,811, and U.S. Pat. No. 5,965,631. The amount of antimicrobial component contained in the lenses of the invention is up to about 200,000 μg/gm, preferably, about 0.01 μg/gm to about 10,000 μg/gm, more preferably, about 0.1 μg/gm to about 100 μg/gm. When silver is used in the invention, the silver content of the lenses of the invention ranges from about 0.1 μg/gm to about 500 μg/gm, preferably about 1 μg/gm to about 100 μg/gm, more preferably about 10 μg/gm to about 70 μg/gm.

Hard contact lenses are made from polymers that include but are not limited to polymers of poly(methyl)methacrylate, silicon acrylates, fluoroacrylates, fluoroethers, polyacetylenes, and polyimides, where the preparation of representative examples may be found in JP 200010055, JP 6123860 and U.S. Pat. No. 4,330,383. Intraocular lenses of the invention can be formed using known materials. For example, the lenses may be made from a rigid material including, without limitation, polymethyl methacrylate, polystyrene, polycarbonate, or the like, and combinations thereof. Additionally, flexible materials may be used including, without limitation, hydrogels, silicone materials, acrylic materials, fluorocarbon materials and the like, or combinations thereof. Typical intraocular lenses are described in WO 0026698, WO 0022460, WO 9929750, WO 9927978, WO 0022459, and JP 2000107277. U.S. Pat. Nos. 4,301,012; 4,872,876; 4,863,464; 4,725,277; 4,731,079. All of the references mentioned in this application are hereby incorporated by reference in their entirety.

Antimicrobial lenses prepared from antimicrobial components and the aforementioned formulations may be coated with a number of agents that are used to coat the lenses. This additional external lens coating may be used to increase the comfort of the lenses or to further slow down the release of silver to the surrounding tissues. Suitable coating procedures, compositions, and methods include, but are not limited to those disclosed in U.S. Pat. Nos. 6,087,415, 5,779,943, 5,275,838,4,973,493, 5,135,297, 6,193,369, 6,213,604, 6,200,626, and 5,760,100 and these patents are hereby incorporated by reference for those procedures, compositions, and methods.

Further, the invention includes an antimicrobial lens comprising, at least one antimicrobial component having a duration of antimicrobial activity greater than that of a lens which has not been treated with an antimicrobial component.

The terms lens and antimicrobial have their aforementioned meanings and preferred ranges. The phrase “duration of antimicrobial activity” means the amount of time that the lenses of the invention reduce microbial colonization. The duration of antimicrobial activity can be tested by a broth assay or a vortex assay.

Still further, the invention includes a method of reducing the adverse effects associated with microbial colonization in the ocular regions of a mammal comprising placing an antimicrobial lens comprising at least one antimicrobial component on the eye of a mammal.

The phrase “adverse effects associated with microbial colonization” include, but are not limited to, contact lens ocular inflammation, contact lens related peripheral ulcers, contact lens associated red eye, infiltrative keratitis, microbial keratitis, and the like. The term mammal means any warm blooded higher vertebrate, and the preferred mammal is a human.

Yet further, the invention includes a method of producing an antimicrobial lens comprising at least one antimicrobial component, wherein the method comprises the steps of

(a) forming a lens

(b) contacting a lens with an antimicrobial containing solution comprising at least one antimicrobial component; and

(c) optionally, heating said lens either before or after said contacting.

An antimicrobial containing solution consists essentially of at least one antimicrobial component and water and may be suitable for use in packaging, sterilization and/or storage of a lens. The antimicrobial containing solution is stable under use conditions and compatible and non-irritating to the ocular environment. Thus, the antimicrobial solution does not contain any component, such as but not limited to alcohols, in quantities, which would be sufficient to cause stinging or ocular irritation.

The antimicrobial component may conveniently be incorporated on and/or in said lens by adding a metal salt comprising the desired metal ion to water to form the antimicrobial containing solution. The metal salt is substantially soluble in the antimicrobial containing solution and remains soluble under packaging, sterilization and storage conditions. Substantially soluble means that the metal salt should not precipitate out in amounts which would be detrimental to the lens. Preferably the metal salts have a solubility constant, Kₛₚ, in the selected solution of at least about 1×10⁻³⁵ and more preferably of greater than about 1×10⁻¹⁷. Suitable counterions include acetate, citrate, lactate, sulfate, combinations thereof and the like. The preferred solutions are aqueous solutions.

Providing a lens that fits a wide range of patients has been a quest of eye care practitioners and lens manufacturers for a number of years. In order to produce such a lens, many variables, such as lens material, design, surface treatments, and additional components such as UV blockers, ophthalmic drugs, tints, dyes and pigments can come into play. For example it has been shown that if one adds too much of an additional component, such as an antimicrobial agent, a lens that will become adhered to the eye is produced. However, if one is attempting to produce an antimicrobial lens, a balance should be struck between producing a lens that contains enough antimicrobial agent to produce the desired effect without producing a lens that adheres to the eye.

One way to assess if a lens fit is acceptable (i.e. the lens is not adhered) is to assess the tightness of the fit of a lens. (Young, G. et al., Influence of Soft Contact Lens Design on Clinical Performance, Optometry and Vision Science, Vol. 70, No., 5 pp. 394-403) Tightness of a lens may be assessed using an in vivo push up test. In that test, a lens is placed on a patient's eye. Subsequently, an eye care practitioner presses his or her finger digitally upward against the lower lid of the patient's eye and observes whether the lens moves on the patient's eye. Lenses that do not move under these circumstances are not considered to be a good fit for the patient's eye, for lenses that are too tight will not move when the patient blinks and may become uncomfortable. Therefore one of the objects of this invention is to produce an antimicrobial lens that does not adhere to the patient's eye.

To meet this objective, the invention includes an antimicrobial lens comprising an antimicrobial component, preferably silver, wherein said lens has sufficient movement on the eye of a patient.

The phrase “movement on the eye of a patient” refers to whether a lens, when placed on the eye of a patient moves under the push-up test described above. This test is described in further detail in Contact Lens Practice, Chapman & Hall, 1994, edited by M. Ruben and M. Guillon, pgs. 589-99. Under this test lenses are given an −2 rating if they do not move on the eye of a patient in the digital push-up test. Therefore lenses that score greater than a “−2” on the digital push-up test are lenses that move on a patient's eye. In a statistically significant patient population, lenses that may be suitable for one patient may not be suitable for another. Therefore, lenses having sufficient movement are lenses that move on at least about 50 to about 100% of a given patient population. Preferably, said lenses move on about 75 to about 100%, of patients, more preferably, about 80 to about 100%, most preferably about 90 to about 100%.

The term “silver” refers to silver metal of any oxidation state (Ag⁰, Ag¹⁺ or Ag²⁺) that is incorporated in and/or on a lens, where the preferred oxidation state is oxidized silver. The term “silver ion” refers to any ion of silver.

The term “cadmium” refers to cadmium metal of any oxidation state that is incorporated in and/or on a lens. The term “cadmium ion” refers to any ion of cadmium. Cadmium is incorporated in and/or on the lenses in an amount effective to be an antimicrobial.

The term “zinc” refers to zinc metal of any oxidation state that is incorporated in and/or on a lens. The term “zinc ion” refers to any ion of zinc. Zinc is incorporated in and/or on the lenses in an amount effective to be an antimicrobial.

The term “copper” refers to copper metal of any oxidation state that is incorporated in and/or on a lens. The term “copper ion” refers to any ion of copper. Copper is incorporated in and/or on the lenses in an amount effective to be an antimicrobial.

The term “gold” refers to gold metal of any oxidation state that is incorporated in and/or on a lens. The term “gold ion” refers to any ion of gold. Gold is incorporated in and/or on the lenses in an amount effective to be an antimicrobial.

The term “platinum” refers to platinum metal of any oxidation state that is incorporated in and/or on a lens. The term “platinum ion” refers to any ion of platinum. Platinum is incorporated in and/or on the lenses in an amount effective to be an antimicrobial.

The term “palladium” refers to palladium metal of any oxidation state that is incorporated in and/or on a lens. The term “palladium ion” refers to any ion of palladium. Palladium is incorporated in and/or on the lenses in an amount effective to be an antimicrobial.

The term “tin” refers to tin metal of any oxidation state that is incorporated in and/or on a lens. The term “tin ion” refers to any ion of tin. Tin is incorporated in and/or on the lenses in an amount effective to be an antimicrobial.

The term “cobalt” refers to cobalt metal of any oxidation state that is incorporated in and/or on a lens. The term “cobalt ion” refers to any ion of cobalt. Cobalt is incorporated in and/or on the lenses in an amount effective to be an antimicrobial.

The term “nickel” refers to nickel metal of any oxidation state that is incorporated in and/or on a lens. The term “nickel ion” refers to any ion of nickel. Nickel is incorporated in and/or on the lenses in an amount effective to be an antimicrobial.

The term “bismuth” refers to bismuth metal of any oxidation state that is incorporated in and/or on a lens. The term “bismuth ion” refers to any ion of bismuth. Bismuth is incorporated in and/or on the lenses in an amount effective to be an antimicrobial.

Silver ions are a preferred metal ion, and for conciseness, silver ions will be referred to in describing the method for incorporation of the antimicrobial component. However, one of skill in the art will appreciate that the use of silver in the discussion below is exemplary and not limiting.

Silver ions may be incorporated on and in the lens by exposing the cured and hydrated lens to a silver salt containing solution such as silver nitrate in deionized water (“Dl”). Other sources of silver, include but are not limited to, silver acetate, silver citrate, silver lactate, and silver sulfate. The concentration of silver in these solutions can vary from the concentration required to add a known quantity of silver to a lens to a saturated solution. In order to calculate the concentration of the silver solution needed, the following calculation is used: the concentration of silver solution is equal to the desired amount of silver per lens, multiplied by the dry weight of the lens divided by the total volume of treating solution.

Silver solution concentration (μg/ml)=[desired silver in lens (μg/g)×average dry lens weight (g)]/total volume of treating solution (ml) For example, if one requires a lens containing 40 μg/g of silver, the dry weight of the lens is 0.02 g, and the vessel used to treat said lens has a volume of 3 mL, the required silver concentration would be 0.27 μg/ml.

As used herein “heating” has its common meaning where the temperature at which the lens is heated is from about 20° C. to about 130° C.

The present invention further includes a method of adding an antimicrobial component to a lens that does not contain an antimicrobial host by exposing the lens to an antimicrobial containing solution. Optionally, the lens is heated at a temperature and for a period of time long enough to incorporate the antimicrobial component on and/or in the lens, in one embodiment, at about 120° C. or higher for about 18 minutes or more. Lower temperatures may be used for longer periods of time, as will be appreciated in the art, for the incorporation of the antimicrobial component on and/or in the lenses. The time for heating is dependent on the temperature used. If the heating is used for incorporation of the antimicrobial component and additionally, sterilization of the lens, the selected conditions (temperature and exposure time) must provide a minimum Sterility Assurance Level (SAL) of at least 10⁻⁶ and render the biological indicator, BI, non-viable in one-half of the sterilization time (referred to as the overkill validation method). Methods for calculating the SAL for different temperatures or exposure times are known in the art. The temperature and exposure times can be varied to accommodate processing constraints, material properties and the like, so long as the necessary SAL and BI overkill are provided.

The sterilization temperature is in Celsius. It will be assumed that the sterilization process is controlled at precisely the sterilization temperature from the beginning to the end of the process. A sterilization process may require heating and cooling phases to attain the sterilization temperature. The period of time that the sterilization process is held at the sterilization temperature is called the exposure time. Even during the exposure time the sterilization process may deviate due to process control and product heating characteristics.

Non-limiting examples of suitable temperatures and exposure times for sterilization are listed in the following table. All numbers are prefaced by the word “about”.

| Sterilization Temperature (° C.) | Sterilization Time (minutes) |
|---|---|
| 100 | 4638 |
| 105 | 1467 |
| 110 | 464 |
| 115 | 147 |
| 120 | 46 |
| 125 | 15 |
| 130 | 5 |

In one embodiment of the invention, a lens, that does not contain an antimicrobial host, is exposed to an antimicrobial containing solution, and the lens in the antimicrobial containing solution is heated at a sufficient temperature and for sufficient time to both incorporate the antimicrobial on and/or in the lens and to sterilize the lens, in one step. The preferred temperature and time is about 122° C. or higher for about 18 minutes.

In another embodiment of the invention, a lens, which does not contain an antimicrobial host is exposed to an antimicrobial containing solution, and the lens in the antimicrobial containing solution is heated at a sufficient temperature and for a sufficient time to incorporate the antimicrobial on and/or in the lens. Optionally, the lens may be sterilized by heat or other methods before the antimicrobial has been incorporated on and/or in the lens. The preferred sterilization temperature and time is about 122.5° C. or higher for about 18 minutes.

Antimicrobial containing solutions include, but are not limited to, solutions of antimicrobial components that confer antimicrobial activity to the lenses such as solutions comprising silver ions, preferably silver nitrate, silver acetate, silver citrate, silver iodide, silver lactate, and silver sulfate; cadmium ions, preferably cadmium nitrate, cadmium acetate, cadmium citrate, cadmium iodide, cadmium lactate, and cadmium sulfate; zinc ions, preferably zinc nitrate, zinc acetate, zinc citrate, zinc iodide, zinc lactate, and zinc sulfate; copper ions, preferably copper nitrate, copper acetate, copper citrate, copper iodide, copper lactate, and copper sulfate; gold ions, preferably gold nitrate, gold acetate, gold citrate, gold iodide, gold lactate, and gold sulfate; platinum ions, preferably platinum nitrate, platinum acetate, platinum citrate, platinum iodide, platinum lactate, and platinum sulfate; preferably; palladium ions, preferably palladium nitrate, palladium acetate, palladium citrate, palladium iodide, palladium lactate, and palladium sulfate; cobalt ions, preferably cobalt nitrate, cobalt acetate, cobalt citrate, cobalt iodide, cobalt lactate and cobalt sulfate; nickel ions, preferably nickel nitrate, nickel acetate, nickel citrate, nickel iodide, nickel lactate, and nickel sulfate; tin ions, preferably tin nitrate, tin acetate, tin citrate, tin iodide, tin lactate, and tin sulfate; and bismuth ions, preferably bismuth nitrate, bismuth acetate, bismuth citrate, bismuth iodide, bismuth lactate, and bismuth sulfate and other antimicrobial containing solutions.

One embodiment of this invention incorporates silver in and/or on a lens that does not contain an antimicrobial host. Silver is preferably incorporated into the lens with a silver salt solution at a silver concentration of about 0.01 μg/ml to about 500,000 μg /ml, preferably about 0.1 μg/ml to about 100 μg/ml, more preferably at about 1 to about 70 μg/ml and in some embodiments at about 20 μg/ml silver in a silver nitrate solution in Dl water. The lens is placed in a silver nitrate solution, preferably 50 μl, and a buffering solution is added (for example without limitation, borate buffer solution) preferably about 950-1000 μl. As used herein the term buffering solution refers to any solution which is capable of adjusting the pH of the antimicrobial containing solution, to the desired level, which is preferably between about 6 to about 8, more preferably about 7.

It is preferable to place the lens and solution in the packaging (including, but not limited to, thermoplastic packaging or glass packaging) that it will be stored in at this time because the lens can then be sterilized in the packaging and does not have to be transferred and re-sterilized. However, it is not required to place the lens and solution in the packaging at this time.

The lens is then heated to 122.5° C. or higher for about 18 minutes or more (about 48 minutes or more including time required to ramp up and down to and from 122.5° C.). In this embodiment, silver is on and/or in the lens, at at least about 0.1 μg silver/g lens dry weight.

The lenses, in one embodiment, are placed in a packing solution until the lenses are used. The packing solution is prepared so that, for a sufficient storage period, preferably at least about 6 months, more preferably at least about 2 years, (1) the lens remains hydrated in an ophthalmically compatible fluid and (2) the antimicrobial component in and on the lens does not precipitate out or form an insoluble complex with the ingredients of the packing solution.

In one embodiment, the packing solution has an osmolarity substantially similar to that of human tears and in some embodiments comprises 0.85% sodium chloride, 0.93% boric acid, 0.19% sodium borate. Other components in various amount are well known to those of skill in the art. In some embodiments the packing solution is substantially free from components which complex with the selected antimicrobial component.

In an embodiment of then present invention, the antimicrobial component is soluble in the packing solution, suppressing microbiological activity in the packing solution.

In order to illustrate the invention the following examples are included. These examples do not limit the invention. They are meant only to suggest a method of practicing the invention. Those knowledgeable in contact lenses as well as other specialties may find other methods of practicing the invention. However, those methods are deemed to be within the scope of this invention.

### EXAMPLE 1

Etafilcon A lenses, sold as ACUVUE® lenses (commercially available from Johnson & Johnson), without antimicrobial hosts, were rinsed in Dl water 8 times at 30 minute intervals. Each lens was placed in 500 μl of silver nitrate solution containing approximately 2 micrograms per ml silver and a borate buffering solution was added to reach a pH of about 7.

The lenses were then heated to about 122.5° C. for about 30 minutes (about 48 minutes were required to include ramping up and down time). The lenses were found to have at least about 40 μg silver/g lens dry weight.

### EXAMPLE 2

Five ACUVUE® lenses (commercially available from Johnson & Johnson), without antimicrobial hosts, were placed separately into glass vials with AgNO₃ (50 ppm Ag) in 3 ml borate buffered water (1.85% boric acid and 0.37% sodium borate). The vials were heated in an oven at 50° C. for 40 minutes. They were then removed, blotted, and analyzed for silver. The lenses were found to contain 4.9 (±0.2) ppm silver based on dry lens weight.

### EXAMPLE 3

ACUVUE® lenses (commercially available from Johnson & Johnson), without antimicrobial hosts, were treated with silver as described in Example 2, except that the lenses were heated at 50° C., 80° C. or at autoclave temperature (121° C.). The results are contained in Table 1.

TABLE 1

| Post treatment | |
|---|---|
| temperature | ppm Ag in lens |
| 50° C. | 4.9 ± 0.2 |
| 80° C. | 4.4 ± 0.3 |
| 121° C. (autoclave) | 3.1 ± 0.6 |

### EXAMPLE 4

Lenses which were prepared as described in Example 1, were rinsed 8 times at 30 minutes per rinse in distilled Dl water at 6 ml/lens in each rinse, and subsequently were tested for the concentration of silver over a period of 5 days while being stored in 2.2 ml of artificial tear fluid (ATF), which was replaced every 24 hours.

TABLE 2
ATF FORMULA

| | |
|---|---|
| NaCl | 16.6 grams |
| NaH₂PO₄H₂O | 0.92 grams |
| Na₂HPO₄7H₂O | 8.80 grams |
| Gamma-globulins (bovine) | 2.4 grams |
| albumin (chicken eggs) | 2.4 grams |
| Lysozyme | 2.4 grams |

All added to 2.0 Liters of distilled/deionized water.

The silver analysis reported in Table 3, below, was done using an Instrumental Neutron Activation Analysis (INAA), which is a method of elemental analysis based on the artificial induction of specific radionuclides by irradiation with neutrons in a nuclear reactor. Irradiation of the sample is followed by the quantitative measurement of the characteristic gamma rays emitted by the decaying radionuclides. The gamma rays detected at a particular energy are indicative of a particular radionuclide's presence, allowing for a high degree of specificity. The INAA procedure used to quantify silver content in contact lens material used the following two nuclear reactions:

In the activation reaction, ¹¹⁰Ag is produced from stable ¹⁰⁹Ag (isotopic abundance=48.16%) after capture of a radioactive neutron produced in a nuclear reactor.

In the decay reaction, 110 Ag (□½=24.6 seconds) decays primarily by negatron emission proportional to initial concentration with an energy characteristic to this radio-nuclide (657.8 keV).

The gamma-ray emission specific to the decay of ¹¹⁰Ag from irradiated standards and samples are measured by gamma-ray spectroscopy, a well-established pulse-height analysis technique, yielding a measure of the concentration of the analyte.

All samples are dried in a vacuum oven at 80° C. and less than four inches of Hg for at least four hours. Results are reported as an average of five test samples.

TABLE 3

| | | Standard. Deviation |
|---|---|---|
| Time (days) | Silver (ppm) | (N = 3) |
| 0 | 43 | 2.57 |
| 1 | 3 | 0.49 |
| 2 | 2.5 | 0.26 |
| 3 | 2 | 1.25 |
| 4 | 2.2 | 0.35 |
| 5 | 1.5 | 0.50 |

Still, yet another method of incorporating silver into lenses is to produce lenses containing silver and an oxidizing agent. Often when silver is incorporated into lenses, the lenses turn from clear to a discolored appearance over time. This discoloration may compromise the visual acuity of the lens and can be esthetically unappealing to the patient. Therefore, preventing or reducing discoloration is a goal of any lens producer. To meet this goal, the invention includes an antimicrobial lens comprising silver and an oxidizing agent.

### EXAMPLE 5

ACUVUE® lenses (commercially available from Johnson & Johnson), without antimicrobial hosts, were treated with a silver nitrate solution in varying concentrations. The lenses were placed in glass vials containing either borate solution (1.85% boric acid and 0.37% sodium borate) or packing solution (0.85% sodium chloride, 0.93% boric acid, 0.19% sodium borate, and 0.01% EDTA). Silver nitrate solution was added to each vial in the appropriate volume to achieve the desired level of silver. The total solution volume per vial was3 ml.

The lenses were autoclaved at 121° C. for 120 minutes or 30 minutes (see Table 5). All of the lenses were rinsed with deionized water at approximately 25 ml per lens for a total of eight times at a minimum of about 30 minute intervals.

The lenses were analyzed for silver content and activity against bacterial adhesion as follows. In the vortex assay a culture of Pseudomonas aeruginosa, ATCC# 15442 (ATCC, Rockville, Md.) is grown overnight in a nutrient medium. The bacterial inoculum is prepared to result in a final concentration of 1×10⁶ colony forming units (cfu)/ml. Three lenses of the invention are rinsed with phosphate buffered saline (“PBS”) pH 7.4±0.2. Each washed contact lens is combined with two ml of the bacterial inoculum into a glass vial, which is agitated in a shaker-incubator for two hr. at 37±2° C. removed from the solution and subsequently incubated for 22 to 24 hours at 37±2° C. Each lens is washed with PBS, placed into 10 ml of PBS containing 0.05% Tween™ 80 and spun at 2000 rpm for three minutes. The resulting supernatant is enumerated for viable bacteria, and the results of the detectable viable bacteria attached to three lenses are averaged. Table 5 summarizes the experimental conditions and silver and bacterial adhesion reduction results.

TABLE 5

| Autoclave | | Avg. | | | |
|---|---|---|---|---|---|
| time | Solution in | Ag/lens | | | Bacterial |
| (min) | vial | ppm | STD | % RSD | reduction |
| 120 | Borate | 3.08 | 0.61 | 19.8 | 1.28 |
| | solution | | | | |
| 30 | Packing | 0.60 | 0.40 | 66.7 | 1.05 |
| | solution | | | | |
| 30 | Borate | 40.86 | 0.61 | 1.5 | 1.79 |
| | solution | | | | |

The reduction in bacterial adhesion results follow the average silver content trend. All three silver concentrations in Example 5 showed at least 1 log reduction in bacteria as shown in FIG. 1.

The following abbreviations were used in the examples

Dl water=deionized water

HEMA=hydroxyethyl methacrylate

MAA=methacrylic acid;

MMA=methyl methacrylate

TMI=dimethyl meta-isopropenyl benzyl isocyanate

mPDMS=mono-methacryloxypropyl terminated polydimethylsiloxane (MW 800-1000)

TBACB=tetrabutyl ammonium-m-chlorobenzoate

TEGDMA=tetraethyleneglycol dimethacrylate

THF=tetrahydrofuran

TRIS=tris(trimethylsiloxy)-3-methacryloxypropylsilane

The formulations that were used to prepare the lenses of the invention were prepared as follows.

It is understood that while the invention has been described in conjunction with the detailed description thereof, that the foregoing description is intended to illustrate and not limit the scope of the invention, which is defined by the scope of the appended claims. Other aspects, advantages, and modifications are evident from a review of the following claims.

What is claimed is:

1. A method of producing an antimicrobial lens without an antimicrobial host comprising placing a lens in an antimicrobial containing solution.

2. The method of claim 1 wherein the lens is contacted with the antimicrobial containing solution under conditions sufficient to incorporate an effective amount of an antimicrobial component on and/or in the lens.

3. The method of claim 2 wherein the antimicrobial component is present in the lens.

4. The method of claim 2 wherein the antimicrobial component is present on the lens.

5. The method of claim 2 wherein the antimicrobial component is present in and on the lens.

6. The method of claim 5 wherein the antimicrobial containing solution comprises at least one antimicrobial component in an amount up to about 200,000 μg/gm.

7. The method of claim 5 wherein the antimicrobial containing solution comprises at least one antimicrobial component in an amount between about 0.01 μg/gm to about 10,000 μg/gm.

8. The method of claim 5 wherein the antimicrobial containing solution comprises at least one antimicrobial component in an amount between about 0.1 μg/gm to about 100 μg/gm.

9. The method of claim 2 wherein the antimicrobial containing solution comprises silver nitrate and a buffering solution.

10. The method of claim 2 wherein the antimicrobial containing solution comprises silver nitrate.

11. The method of claim 10 wherein silver is present in the lens at about 0.1 μg/gm to about 500 μg/gm.

12. The method of claim 10 wherein silver is present in the lens at about 0.1 μg/gm to about 100 μg/gm.

13. The method of claim 10 wherein silver is present in the lens at about 20 μg/gm to about 70 μg/gm.

14.The method of claim 5 wherein the antimicrobial containing solution has a concentration of the antimicrobial component of about 0.01 μg/ml to about 500,000 μg/ml.

15. The method of claim 5 wherein the antimicrobial containing solution has a concentration of the antimicrobial component of about 0.1 μg/ml to about 100 μg/ml.

16. The method of claim 5 wherein the antimicrobial containing solution has a concentration of the antimicrobial component of about 1 to about 70 μg/ml

17. The method of claim 5 wherein the antimicrobial containing solution has a concentration of the antimicrobial component of about 20 μg/ml.

18. The method of claim 5 wherein the antimicrobial containing solution comprises at least one metal ion selected from the group consisting of silver ions, cadmium ions, zinc ions, copper ions, gold ions, platinum ions, palladium ions, bismuth ions, tin ions, cobalt ions, nickel ions and combinations thereof.

19. The method of claim 5 wherein the antimicrobial containing solution comprises at least one metal salt selected from the group consisting of silver nitrate, silver acetate, silver citrate, silver iodide, silver lactate, silver sulfate and combinations thereof.

20. The method of claim 2 wherein the conditions comprise a temperature of about 20° C. for a time of at least about 15 minutes to about 130° C. for a time of at least about 5 minutes.

21. The method of claim 20 wherein the conditions comprise a temperature of about 120° C. for a time of at least about 15 minutes.

22. The method of claim 5 wherein the antimicrobial containing solution comprises at least one metal ion and at least one counterion.

23. The method of claim 22 wherein the counterion is selected from the group consisting of acetate, citrate, iodide, lactate, sulfate, and combinations thereof.

24. The method of claim 9 wherein the buffering solution buffers the antimicrobial containing solution and to a pH of about 7.

25. The method of claim 9 wherein the buffering solution is a borate solution.

26. The method of claim 2 wherein the conditions are sufficient to sterilize the lens concurrently with the incorporation of the antimicrobial component.

27. An antimicrobial lens comprising a contact lens with an antimicrobial component, in the absence of an antimicrobial host, incorporated on and/or in the lens by exposure to an antimicrobial containing solution.

28. The lens of claim 27 wherein the antimicrobial component is present in and on the lens at up to about 200,000 ppm.

29. The lens of claim 27 wherein the antimicrobial component is present in and on the lens at least about 0.1 ppm to about 10,000 ppm.

30. The lens of claim 27 wherein the antimicrobial component is present in and on the lens at least about 10 ppm to about 100 ppm.

31. The lens of claim 27 wherein the antimicrobial containing solution comprises silver nitrate and a buffering solution.

32. The lens of claim 27 wherein the antimicrobial containing solution comprises silver nitrate.

33. The lens of claim 31 wherein the silver is present in the lens at about 0.1 ppm to about 500 ppm.

34. The lens of claim 31 wherein the silver is present in the lens at about 0.1 ppm to about 100 ppm.

35. The lens of claim 31 wherein the silver is present in the lens at about 20 ppm to about 70 ppm.

36. The lens of claim 31 wherein the silver is present in the lens at about 40 ppm to about 50 ppm.

37. The lens of claim 27 wherein the antimicrobial containing solution has a concentration of the antimicrobial component of about 0.1 μg/ml to about 500,000 μg/ml.

38. The lens of claim 27 wherein the antimicrobial containing solution has a concentration of the antimicrobial component of about 1.0 μg/ml to about 100 μg/ml.

39. The lens of claim 27 wherein the antimicrobial containing solution has a concentration of the antimicrobial component of about 20 μg/ml.

40. The lens of claim 27 wherein the antimicrobial containing solution comprises at least one metal ion selected from the group consisting of silver ions, cadmium ions, zinc ions, copper ions, gold ions, platinum ions, palladium ions, bismuth ions, tin ions, cobalt ions, nickel ions and combinations thereof.

41. The lens of claim 27 wherein the antimicrobial containing solution comprises at least one metal salt selected from the group consisting of silver nitrate, silver acetate, silver citrate, silver lactate, silver sulfate and combinations thereof.

42. The lens of claim 27 wherein the antimicrobial containing solution comprises at least one metal ion and at least one counterion.

43. The lens of claim 42 wherein the counterion is selected from the group consisting of acetate, citrate, iodide, lactate, sulfate, and combinations thereof.

44. The lens of claim 31 wherein the buffering solution buffers the antimicrobial containing solution and to a pH of about 7.

45. The lens of claim 31 wherein the buffering solution is a borate solution.

46. A method of storing an antimicrobial lens without an antimicrobial host comprising placing a lens in a packing solution, wherein the lens is prepared according to claim 1, and the antimicrobial component does not complex with ingredients of the packing solution.

47. The method of claim 46 wherein the packing solution comprises sodium chloride, boric acid and sodium borate.

48. The method of claim 47 wherein the sodium chloride is present at about 0.85%, the boric acid is present at about 0.93% and the sodium borate is present at about 0.19%.

49. The method of claim 48 wherein the antimicrobial component is soluble in the packing solution.

50. The method of claim 49 wherein the antimicrobial component comprises at least one metal ion which suppresses microbiological activity in the packing solution.

51. The method of claim 48 wherein the lens is stored for up to about 2 years.

52. The method of claim 48 wherein the lens is stored for at least about 6 months.

53. An antimicrobial lens comprising a contact lens with silver, in the absence of an antimicrobial host, incorporated in and on the lens by exposure to a silver nitrate solution with a borate buffering solution, said exposure comprises placing the lens in the solution and heating the lens and solution.
